(19) United States
(12) Patent Application Publication
(10) Pub. No.: US 2026/0054486 A1
(43) Pub. Date: Feb. 26, 2026

(54) PRINTING APPARATUS

(71) Applicant: SEIKO EPSON CORPORATION, Tokyo (JP)

(72) Inventor: Daisuke HIRUMA, MATSUMOTO-SHI (JP)

(21) Appl. No.: 19/309,916

(22) Filed: Aug. 26, 2025

(30) Foreign Application Priority Data
Aug. 26, 2024 (JP) 2024-144084

(51) Int. Cl. B41J 2/165; B41J 2/17; B41J 11/02; B41J 25/00; B41J 29/13

(52) U.S. Cl. CPC B41J 2/16511; B41J 2/16544; B41J 2/1721; B41J 11/02; B41J 25/001; B41J 29/13; B41J 2002/16594

(57) ABSTRACT

A printing apparatus includes a platen configured to support a medium, a head configured to eject a liquid from a nozzle to the medium supported by the platen, a carriage configured to hold the head and to be movable in a scanning direction, and a capping unit configured to cap the head to seal the nozzle, wherein a part of the carriage overlaps the platen in a plan view in a state where the capping unit caps the head.

The present application is based on, and claims priority from JP Application Serial Number 2024-144084, filed Aug. 26, 2024, the disclosure of which is hereby incorporated by reference herein in its entirety.

### BACKGROUND

### 1. Technical Field

The present disclosure relates to a printing apparatus.

### 2. Related Art

In the related art, as disclosed in JP-A-2021-59073, there is known a printing apparatus including a head mounted on a carriage and maintenance units disposed at both sides of a platen, and having a configuration in which the maintenance unit includes a capping unit that covers the head.

JP-A-2021-59073 is an example of the related art.

However, in the printing apparatus described above, there is room for improvement in space efficiency in the printing apparatus such that the head finally reaches a position of the capping unit after the carriage passes the platen, and there is a concern that the printing apparatus may grow in size.

### SUMMARY

A printing apparatus includes a platen configured to support a medium, a head configured to eject a liquid from a nozzle to the medium supported by the platen, a carriage configured to hold the head and to be movable in a scanning direction, and a capping unit configured to cap the head to seal the nozzle, wherein a part of the carriage overlaps the platen in a plan view in a state where the capping unit caps the head.

### BRIEF DESCRIPTION OF THE DRAWINGS

FIG. 1 is a perspective view showing a printing apparatus.

FIG. 2 is a cross-sectional view of principal parts of a printing unit and a maintenance unit viewed from above.

FIG. 3 is a cross-sectional view of the principal parts of the printing unit and the maintenance unit viewed from front.

### DESCRIPTION OF EMBODIMENTS

### 1. Printing Apparatus

An embodiment of a printing apparatus 1 will hereinafter be described with reference to the drawings. Note that directions in the drawings are described using a three-dimensional coordinate system. For the sake of convenience of explanation, a positive direction of a Z axis is referred to as an upward direction or simply above, a negative direction thereof is referred to as a downward direction or simply below, a positive direction of an X axis is referred to as a rightward direction or simply right, a negative direction thereof is referred to as a leftward direction or simply left, a positive direction of a Y axis is referred to as a forward direction or simply front, and a negative direction thereof is referred to as a rearward direction or simply rear.

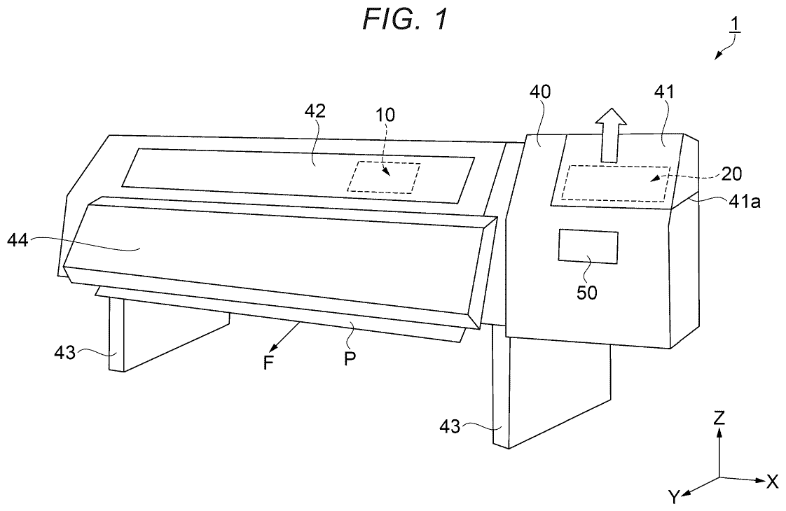

As illustrated in FIG. 1, in the printing apparatus 1, a printing unit 10, a maintenance unit 20, and so on are housed inside an exterior housing 40 as a case. The exterior housing 40 is supported by left and right leg portions 43. The maintenance unit 20 is disposed at the right side of the printing apparatus 1.

A cover 42 that covers a central portion of the printing apparatus 1 and through which the printing unit 10 which is in printing operation can visually be recognized is attached to the exterior housing 40. Further, an openable cover 41 which can open and close an upper side and a right side of the maintenance unit 20 is attached to the exterior housing 40. As described later, when the openable cover 41 opens and a user works on the maintenance unit 20, it is possible to secure sufficient spaces at the upper side and the right side thereof.

A medium P is conveyed along a conveyance direction F from the rear toward the front by a conveyance mechanism including a conveyance motor, a conveyance roller, and so on (all not illustrated). The medium P may be, for example, paper or resin such as a film.

Note that the medium P may have an elongated shape and may be set behind the printing apparatus 1 in a state of being wound in a roll shape. In this case, the printing apparatus 1 may include a winding unit (not illustrated) in front thereof, and may wind the medium P conveyed in the conveyance direction F by the conveyance mechanism and printed by the printing unit 10.

A liquid attached to the medium P by printing is dried by a heating unit 44 such as an infrared heater. When it is not necessary to dry the medium P, the printing apparatus 1 may not be required to include the heating unit 44.

Further, the printing apparatus 1 includes an input-output unit 50 mounted on a control board (not shown). The input-output unit 50 is a user interface for the user.

The input-output unit 50 is, for example, a touch panel display. The input-output unit 50 includes a display panel as an output unit that displays various types of information, and a detection panel as an input unit. Note that in the input-output unit 50, the input unit may be a keyboard, a mouse, buttons, or the like, and the output unit may be a stand-type liquid crystal display or the like.

A processor (not illustrated) that reads a program stored therein to comprehensively control each unit of the printing apparatus 1 is also mounted on the control board.

The processor is capable of controlling printing by the printing unit 10, maintenance by the maintenance unit 20, and so on based on an input to the input-output unit 50 by the user.

Note that the printing apparatus 1 is, for example, an inkjet printer which is a so-called large-sized liquid ejecting apparatus capable of performing printing on the medium P having a size of A1 or larger. The printing apparatus 1 is provided with an ink tank capable of supplying ink as the liquid and a waste liquid tank (both not illustrated) outside.

### 2. Printing Unit and Maintenance Unit

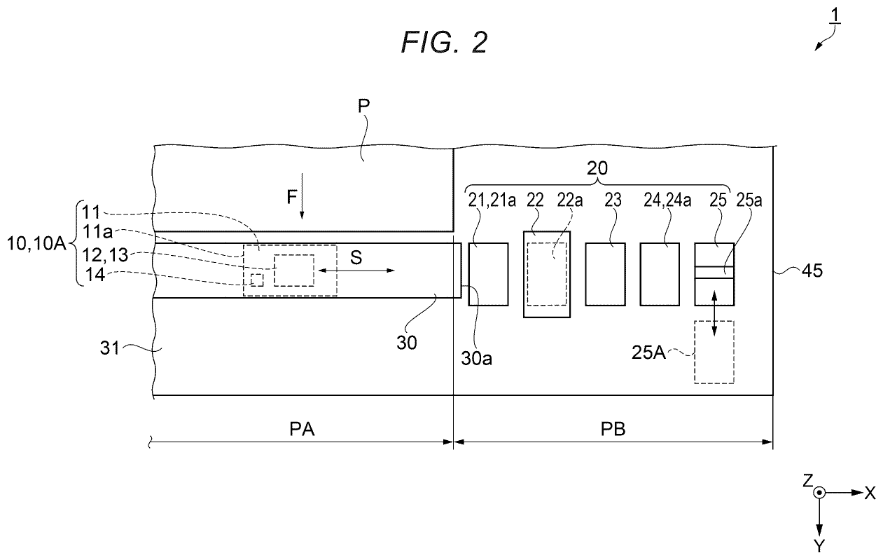

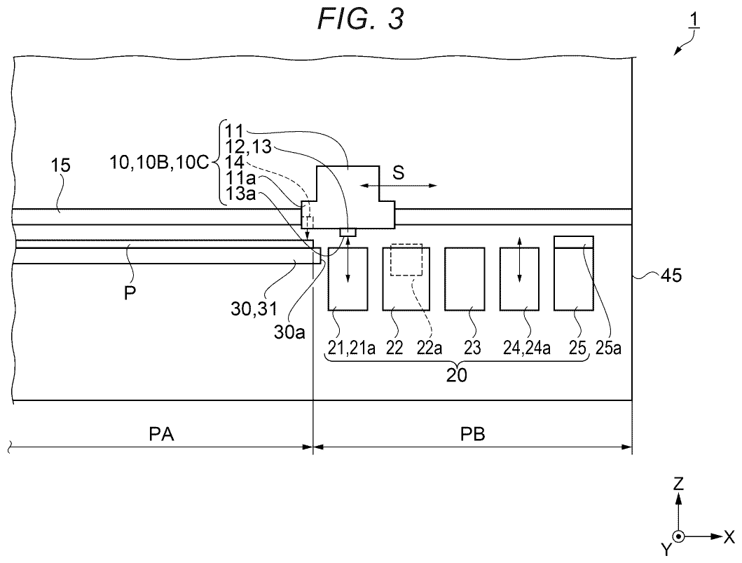

The printing unit 10 and the maintenance unit 20 will be described with reference to FIGS. 2 and 3.

As illustrated in FIG. 2, the medium P is conveyed along the conveyance direction F and is guided by the platen 30 and a paper guide 31.

The printing unit 10 includes a head 12, a carriage 11, and a sensor 14. The carriage 11 holds the head 12 and the sensor 14.

The carriage 11 can be moved in a scanning direction S, which is a left-right direction, along a carriage shaft 15 illustrated in FIG. 3 by a carriage motor (not illustrated). A direction in which the carriage shaft 15 extends is also the scanning direction S. The head 12 is mounted on the carriage 11 and can perform printing by ejecting the ink as the liquid from above onto the medium P supported by the platen 30 while moving together with the carriage 11. The head 12 that performs printing while moving in this manner is referred to as a so-called serial head. Note that in the platen 30, an end at the maintenance unit 20 side and at the right side in the scanning direction S is referred to as a platen end 30a.

As described above, the printing unit 10 is moved in the scanning direction S by the carriage motor. On this occasion, the head 12, the carriage 11, and the sensor 14 mounted on the printing unit 10 also move in the scanning direction S at the same time. In order to simplify the description, the description will hereinafter be presented assuming that any one of these elements moves in the scanning direction S.

As illustrated in FIG. 2, in the scanning direction S, an area where the head 12 of the printing unit 10 can perform printing on the medium P supported by the platen 30 is referred to as a printing area PA. The printing area PA is made narrower than the width in the scanning direction S of the platen 30. Therefore, a right end of the printing area PA is located to the left of the platen end 30a.

The right end of the printing area PA is the rightmost position where the printing apparatus 1 can perform printing. In the example of FIGS. 2 and 3, this position is set as a reference position with which the user aligns a right end of the medium P when the user sets the medium P. That is, the right end of the medium P is located at the rightmost position of the printing area PA. In the printing area PA, a position where the head 12 of the printing unit 10 can perform printing on the medium P is referred to as a printing position 10A.

Note that in the printing apparatus 1, the maintenance unit 20 is disposed at the right side of the reference position for setting the medium P.

Meanwhile, as illustrated in FIG. 3, in the scanning direction S, a region in which the head 12 of the printing unit 10 can be maintained by the maintenance unit 20 is referred to as a maintenance region PB.

The maintenance region PB is a region at the right side of the printing area PA. Further, in the maintenance region PB, a position where the head 12 can be subjected to the maintenance operation by the maintenance unit 20 is referred to as a maintenance position 10B.

The head 12 includes a nozzle 13 that ejects the ink as the liquid onto the medium P. When the head 12 has a plurality of nozzles 13, it is possible to eject a plurality of colors of ink. In this case, the head 12 can eject white ink or the like in addition to CMYK (Cyan, Magenta, Yellow, and Black) ink.

A nozzle surface 13a is a surface of the head 12 provided with the nozzle 13, and is a surface on which the nozzle 13 opens. The nozzle surface 13a faces downward and can be opposed to the platen 30 and the maintenance unit 20.

The carriage 11 includes a sensor 14 that is a detection sensor capable of detecting the medium P. The sensor 14 is, for example, a photosensor that emits detection light downward.

The sensor 14 mounted on the carriage 11 can detect, from above, the medium P supported by the platen 30. The sensor 14 can detect, for example, the presence or absence of the medium P conveyed in the front-rear direction. On this occasion, the sensor 14 can detect a leading end and a trailing end of the medium P thus conveyed. That is, the sensor 14 can detect the length of the medium P.

In addition, for example, the sensor 14 is capable of detecting the presence or absence of the medium P by moving in the scanning direction S together with the carriage 11. On this occasion, the sensor 14 can detect a right end and a left end of the medium P. That is, the sensor 14 is capable of detecting the width of the medium P.

In this way, the sensor 14 is capable of detecting the position and the size of the medium P.

The maintenance unit 20 includes a first capping unit 21, a flushing unit 22, a degassing unit 23, a second capping unit 24, and a wiping unit 25 in this order from the right side of the platen end 30a in the order rightward along the scanning direction S.

These elements are attached to a frame 45. Further, the carriage shaft 15, the platen 30, the paper guide 31, and so on described above are also attached to the frame 45.

The head 12 of the printing unit 10 moves from the printing area PA to the maintenance region PB together with the carriage 11. The head 12 can be subjected to various maintenance operations described below at positions where the head 12 can be opposed to respective units constituting the maintenance unit 20.

Note that the degassing unit 23 degasses a gas contained in the ink located in an ink supply channel to the head 12 with a decompression pump (not shown). The degassing unit 23 does not directly perform maintenance of the head 12, and the arrangement in the maintenance unit 20 can be changed. Further, the degassing unit 23 is not an essential element, and is not required to be provided depending on the printing apparatus 1, and the description thereof will be omitted below.

The first capping unit 21 is disposed at a position closest to the platen 30 in the scanning direction S and at the right side of the platen end 30a.

The first capping unit 21 includes a first cap 21a and a first cap lifting mechanism (not shown). The first cap 21a can seal the nozzle 13 by covering the nozzle surface 13a of the head 12 from below. The first cap lifting mechanism is configured including a first cap motor (not shown) that lifts and lowers the first cap 21a.

Note that covering the nozzle surface 13a with the first cap 21a is also referred to as performing capping or capping. Further, the first capping unit 21 is also referred to simply as a capping unit.

As illustrated in FIG. 3, the head 12 of the printing unit 10 can reach a first capping position 10C at the maintenance position 10B with the carriage 11. The first capping position 10C is a position where the head 12 is opposed to the first cap 21a of the first capping unit 21.

When the head 12 is located at the first capping position 10C, the first cap 21a is lifted by the first cap lifting mechanism of the first capping unit 21. As a result, the first cap 21a can cap the nozzle surface 13a as the maintenance operation.

Note that when the head 12 has a plurality of nozzle arrays, a configuration in which a plurality of first caps 21a is provided for respective nozzle arrays may be adopted. In addition, a configuration in which a single first cap 21a covers a plurality of nozzle arrays may be adopted.

The printing apparatus 1 caps the nozzle surface 13a of the head 12 with the first cap 21a of the first capping unit 21, for example, when printing is stopped, when the printing apparatus 1 is not used, or when the power is turned off. Therefore, the first cap 21a is also referred to as a shelf cap.

The nozzle 13 is sealed by capping with the first capping unit 21. As a result, thickening of the ink in the nozzle 13 is suppressed, and clogging of the nozzle 13 can be suppressed.

When the printing apparatus 1 starts printing after capping, the first cap 21a is lowered by the first cap lifting mechanism, and the first cap 21a is separated from the nozzle surface 13a of the head 12. The head 12 is made movable in the scanning direction S.

In the scanning direction S, the flushing unit 22 is disposed at the right side of the first capping unit 21.

The flushing unit 22 can receive, as the maintenance operation, the ink as the liquid ejected from the nozzle 13 of the head 12. The flushing unit 22 includes an absorber 22a that receives the ink ejected from the nozzle 13 by flushing. The absorber 22a faces upward. Flushing is an operation of forcibly discharging, by ejecting ink from the nozzle 13, foreign matter, air bubbles, altered ink, thickened ink, and so on that cause an ejection failure.

When the head 12 reaches a position opposed to the flushing unit 22 by the carriage 11 at the maintenance position 10B, flushing is performed toward the absorber 22a. The ink thus flushed is collected from the absorber 22a to the external waste liquid tank with a tube or the like.

In the scanning direction S, the second capping unit 24 is disposed at the right side of the flushing unit 22.

The second capping unit 24 includes a second cap 24a and a second cap lifting mechanism (not shown). The second cap 24a can cap the nozzle surface 13a of the head 12 from below. The second cap lifting mechanism is configured including a second cap motor (not shown) that lifts and lowers the second cap 24a.

When the head 12 reaches a position opposed to the second cap 24a of the second capping unit 24 with the carriage 11 at the maintenance position 10B, the second cap 24a is lifted by the second cap lifting mechanism. As a result, the second cap 24a of the second capping unit 24 can cap the nozzle surface 13a of the head 12.

Further, the second capping unit 24 includes a suction pump (not illustrated) communicating with the second cap 24a.

As the maintenance operation, the second capping unit 24 can perform suction cleaning in which the nozzle surface 13a of the head 12 is capped with the second cap 24a to suction the ink in the nozzle 13 of the head 12 with the suction pump. The suction cleaning is an operation of sucking, together with the ink, air bubbles, foreign matters, and so on in the nozzle 13 which cause an ejection failure. The ink subjected to the suction cleaning is collected in the external waste liquid tank from the suction pump with a tube or the like.

Note that the second capping unit 24 is also referred to as a suction unit, and the second cap 24a is also referred to as a suction cap.

Note that when the head 12 has a plurality of nozzle arrays, the printing apparatus 1 repeatedly performs the movement operation of the carriage 11 and the suction cleaning operation of the second capping unit 24 while changing a relative position between the second capping unit 24 and the nozzle arrays. As described above, when the head 12 has the plurality of nozzle arrays, the second capping unit 24 can perform suction cleaning for each of the nozzle arrays.

When the suction cleaning is completed, the second capping unit 24 lowers the second cap 24a with the second cap lifting mechanism to separate the second cap 24a from the nozzle surface 13a of the head 12. The head 12 is made movable in the scanning direction S.

In the scanning direction S, the wiping unit 25 is disposed at the right side of the second capping unit 24.

The wiping unit 25 includes a wiper 25a and a moving mechanism (not shown) as a retraction unit. The wiper 25a can wipe, from below, the nozzle surface 13a which is a surface of the head 12 provided with the nozzle 13. The moving mechanism can move the wiper 25a.

For example, the moving mechanism is configured including a rail and a moving motor (both not shown). The rail can load the wiper 25a, and extends in the front-rear direction crossing the scanning direction S of the head 12. The moving motor can move the wiper 25a placed on the rail in the front-rear direction.

At the maintenance position 10B, the head 12 reaches, due to the carriage 11, a position where the head 12 can be opposed to the wiper 25a of the wiping unit 25. Note that, on this occasion, the wiping unit 25 is retracted to the retraction position 25A described later.

As the maintenance operation, the wiping unit 25 moves the wiper 25a in the front-rear direction with the moving mechanism to wipe the nozzle surface 13a of the head 12. The wiping is an operation of wiping the ink, dust, or the like attached to the nozzle surface 13a that causes an ejection failure.

As shown in FIG. 2, the wiping unit 25 is retracted to the retraction position 25A when wiping is not performed. The retraction position 25A is a position separated forward from a position where the wiping unit 25 can be opposed to the nozzle surface 13a of the head 12. The wiping unit 25 located at the retraction position 25A does not interfere with the printing unit 10 which moves in the scanning direction S.

That is, the wiping unit 25 can be retracted in a direction crossing the scanning direction S due to the moving mechanism. Note that the wiping unit 25 may be retracted to a rear position.

When the wiping unit 25 is located at the retraction position 25A, the head 12 of the carriage 11 can move in the scanning direction S without making contact with the wiper 25a of the wiping unit 25.

In other words, when wiping is performed by the wiping unit 25, the carriage 11 can move to a position where the nozzle surface 13a of the head 12 can be opposed to the wiping unit 25 and where the wiping unit 25 is located before the wiping unit 25 is retracted by the moving mechanism.

That is, the nozzle surface 13a of the head 12 can move, due to the carriage 11, to a position where the nozzle surface 13a can come into contact with the wiper 25a of the wiping unit 25.

The wiper 25a is made of cloth such as nonwoven fabric. The wiper 25a may be elongated cloth wound in a roll shape. In this case, the wiping unit 25 includes a winding unit (not illustrated) that winds the wiper 25a.

The wiping unit 25 can wind the wiper 25a which has been used to wipe the ink on the nozzle surface 13a with the winding unit, and can feed out the wiper 25a which is not used and for wiping next time.

Note that the wiper 25a may be made of rubber or the like having a blade shape.

The wiping with the wiping unit 25 is performed, for example, after a printing operation. Note that after the suction cleaning by the second capping unit 24, the ink may adhere to the nozzle surface 13a of the head 12 in some cases, and therefore, it is preferable to perform wiping.

Note that wiping may disturb, in some cases, a meniscus (an ink surface curved in a concave shape) formed in the nozzle 13. It is preferable for the maintenance unit 20 to perform flushing with the flushing unit 22 after executing wiping to adjust the meniscus in the nozzle 13.

Here, the arrangement in the maintenance unit 20 will further be described. As described above, in the maintenance unit 20, the first capping unit 21, the flushing unit 22, the second capping unit 24, and the wiping unit 25 are arranged in this order rightward in the scanning direction S.

That is, the first capping unit 21 is disposed between the platen 30 and the flushing unit 22 in the scanning direction S. Further, the flushing unit 22 is disposed between the first capping unit 21 and the wiping unit 25 in the scanning direction S.

It is assumed that the head 12 starts printing after flushing by the flushing unit 22. The carriage 11 may be required to be accelerated by the carriage motor in some cases. In this case, for example, it is assumed that the acceleration region in the scanning direction S is from the position of the flushing unit 22 to the position of the platen end 30a of the platen 30 at the left side. After being accelerated, the head 12 can perform printing on the medium P supported by the platen 30.

As described above, the first capping unit 21 is disposed in the acceleration region, that is, between the platen 30 and the flushing unit 22. That is, the carriage motor can use the distance in the scanning direction S due to the arrangement of the first capping unit 21 as the acceleration region. Since in the printing apparatus 1, the first capping unit 21 can be arranged using the acceleration region, it is not necessary to newly prepare a space for the acceleration by the carriage motor, and the size in the scanning direction S can be reduced.

Note that it is preferable for the carriage motor to make the moving speed of the carriage 11 constant during printing by the head 12.

Further, at the right side of the printing apparatus 1, the units constituting the maintenance unit 20 are collectively arranged. As a result, it is possible to reduce a useless space in the printing apparatus 1 which is generated when the units are arranged in a distributed manner, and it is possible to reduce the overall size of the printing apparatus 1.

Further, with such an arrangement, it is possible to minimize the movement when the user performs work on each unit in the maintenance unit 20 as described later. Further, the input-output unit 50 operated by the user is also disposed at the maintenance unit 20 side of the printing apparatus 1, and it is possible to suppress the movement of the user.

FIG. 3 illustrates the printing unit 10 located at the first capping position 10C. On this occasion, the first capping unit 21 can lift the first cap 21a with the first cap lifting mechanism to cap the head 12.

Incidentally, out of the maintenance unit 20, the first capping unit 21 is located at a position closest to the platen 30, the printing area PA, and the medium P in the scanning direction S and the maintenance region PB.

In the state in which the first capping unit 21 caps the head 12 at the first capping position 10C, the carriage end 11a, which is the left end of the carriage 11, is located at the left side of the platen end 30a of the platen 30 in the scanning direction S. That is, on this occasion, in the scanning direction S, the platen end 30a is located at the right side of the carriage end 11a and inside the carriage 11.

In other words, when the carriage 11 is located at the first capping position 10C, the platen end 30a, which is a part of the platen 30, and the carriage end 11a, which is a part of the carriage 11, are located at positions overlapping each other in the scanning direction S.

Further, when the carriage 11 moves toward the first capping unit 21 located at the right side in the scanning direction S, it results in that the carriage 11 can reach the first capping position 10C before passing the platen end 30a of the platen 30.

That is, in a plan view obtained when viewed from above in the state where the first capping unit 21 caps the head 12, there is achieved a positional relationship in which a part of the carriage 11 overlaps the platen 30.

As a result, it is possible to shorten the distance between the platen end 30a of the platen 30 and the first capping unit 21 in the scanning direction S. With such a configuration, the space efficiency in the printing apparatus 1 can be improved, and the size of the printing apparatus 1 in the scanning direction S can be reduced.

It is assumed that the printing apparatus 1 is in a state, for example, when printing is stopped, when the printing apparatus 1 is not used, or when the power is turned off. On this occasion, the printing unit 10 is at the first capping position 10C, and the head 12 is capped by the first capping unit 21.

Incidentally, foreign matters such as paper dust of the medium P or ink mist may float in some cases at the printing area PA side in the printing apparatus 1. Since the printing unit 10 is located at the first capping position 10C, the printing unit 10 and the first capping position 10C can serve as a so-called wall that partitions a space between the printing area PA side and the maintenance region PB side in the scanning direction S.

This wall can prevent foreign matter from entering the maintenance region PB side from the printing area PA side. As a result, it is possible to prevent the foreign matter from entering each of the units constituting the maintenance unit 20.

Further, at the first capping position 10C, the sensor 14 mounted on the carriage 11 is located at the left side in the scanning direction S of the platen end 30a of the platen 30. It results in that in the scanning direction S, the sensor 14 is located at the left side of the platen end 30a and inside the platen 30.

That is, in a plan view obtained when viewed from above in the state where the first capping unit 21 caps the head 12, there is achieved a positional relationship in which the sensor 14 is located above the platen 30. At this position, the sensor 14 can detect the medium P supported by the platen 30.

Even when the first capping unit 21 caps the head 12, such as before the start of printing, the sensor 14 can detect the presence or absence of the medium P conveyed in the front-rear direction, and can detect the leading end and the trailing end of the medium P conveyed. The printing apparatus 1 can shorten the time required for the initial operation before the start of printing.

As described above with reference to FIG. 1, the exterior housing 40 includes the openable cover 41 capable of opening and closing the maintenance unit 20 disposed at the right side of the printing apparatus 1. Note that the exterior housing 40 forms an opening 41a at the boundary with the openable cover 41. That is, the exterior housing 40 includes the openable cover 41 that covers the opening 41a.

The openable cover 41 can open and close the upper side and the right side of the maintenance unit 20 disposed at the right side of the printing apparatus 1. That is, when the openable cover 41 is opened, the opening 41a can expose the upper side and the right side of the maintenance unit 20. It is easy for the user to work on the maintenance unit 20 from above and from the right, and it is easy to obtain sufficient daylighting.

Note that the exterior housing 40 also houses a frame 45 illustrated in FIGS. 2 and 3. The exterior housing 40 at the right side of the opening 41a can cover the frame 45 from the right side.

Here, in order to describe the work on the wiping unit 25 by the user, the description will be presented focusing on the wiping unit 25. The user may perform an operation of replacing the wiper 25a of the wiping unit 25 in some cases.

The wiping unit 25 is located at the rightmost position of the maintenance unit 20. The exterior housing 40 houses at least the wiping unit 25 as a result. The opening 41a of the exterior housing 40 can be exposed toward the scanning direction S as at least the right side of the maintenance unit 20. That is, the exterior housing 40 has the opening 41a at a position in the scanning direction S with respect to the wiping unit 25.

As a result, when the openable cover 41 is opened, the opening 41a can be opened in the scanning direction S which is the right side with respect to the wiping unit 25. A sufficient space can be ensured when the user works on the wiping unit 25 from the right side.

Note that when the openable cover 41 is opened, the opening 41a can also be opened upward with respect to the maintenance unit 20 including the wiping unit 25. It is also possible to ensure a sufficient space when the user works on the maintenance unit 20 including the wiping unit 25 from above.

Further, on this occasion, the wiping unit 25 is retracted to the retraction position 25A. The wiping unit 25 is located at a position that does not interfere with the user when the user performs work from the right side.

The user can operate the input-output unit 50 to move the printing unit 10 to a position at the wiping unit 25 side of the maintenance region PB with the carriage 11. The user can access the printing unit 10 from the right side of the opening 41a. The user can also perform predetermined work such as cleaning on the head 12, the carriage 11, the sensor 14, and so on provided to the printing unit 10. Since the wiping unit 25 is retracted to the retraction position 25A, it is also possible to ensure a sufficient space below the printing unit 10, and in particular, it becomes easy to work on the nozzle surface 13a.

As described above, the printing apparatus 1 includes the platen 30 that supports the medium P, the head 12 that ejects the liquid from the nozzle 13 to the medium P supported by the platen 30, the carriage 11 that holds the head 12 and is movable in the scanning direction S, and the first capping unit 21 that caps the head 12 to seal the nozzle 13. In the plan view in the state where the first capping unit 21 caps the head 12, a part of the carriage 11 overlaps the platen 30.

With such a configuration, it is possible to shorten the distance between the platen end 30a of the platen 30 and the first capping unit 21 in the scanning direction S, and to improve the space efficiency in the printing apparatus 1 to thereby reduce the size in the scanning direction S of the printing apparatus 1.

Although the embodiment is hereinabove described in detail with reference to the drawings, the specific configuration is not limited to the embodiment and may be modified, replaced, deleted, or the like without departing from the gist of the present disclosure.

For example, the maintenance unit 20 is disposed at the right side of the printing apparatus 1 in the above description, but may be disposed at the left side. In this case, the left and the right in the above description are reversed.

What is claimed is:

1. A printing apparatus comprising:
a platen configured to support a medium;
a head configured to eject a liquid from a nozzle to the medium supported by the platen;
a carriage configured to hold the head and to be movable in a scanning direction; and
a capping unit configured to cap the head to seal the nozzle, wherein
a part of the carriage overlaps the platen in a plan view in a state where the capping unit caps the head.

2. The printing apparatus according to claim 1, further comprising
a flushing unit configured to receive the liquid ejected from the nozzle of the head, wherein
the capping unit is disposed between the platen and the flushing unit in the scanning direction.

3. The printing apparatus according to claim 2, further comprising
a wiping unit configured to wipe a surface provided with the nozzle, wherein
the flushing unit is disposed between the capping unit and the wiping unit in the scanning direction.

4. The printing apparatus according to claim 3, wherein
the wiping unit includes a retraction unit that retracts in a direction crossing the scanning direction, and
the carriage is movable to a position where the wiping unit is located before the wiping unit is retracted by the retraction unit.

5. The printing apparatus according to claim 3, further comprising
an exterior housing configured to house at least the wiping unit, wherein
the exterior housing has an opening at a position in the scanning direction with respect to the wiping unit.

6. The printing apparatus according to claim 5, wherein
the exterior housing includes an openable cover that covers the opening.

7. The printing apparatus according to claim 1, wherein
the carriage includes a detection sensor configured to detect the medium, and
the detection sensor is located above the platen in the plan view in the state where the capping unit caps the head.
